(19) United States
(12) Patent Application Publication
(10) Pub. No.: US 2015/0234376 A1
(43) Pub. Date: Aug. 20, 2015

(54) NUMERICAL CONTROLLER FOR MACHINE TOOL WITH EFFICIENT REGULAR INSPECTION FUNCTION FOR COMPONENTS

(71) Applicant: FANUC CORPORATION, Minamitsuru-gun (JP)

(72) Inventor: Hideaki MISOKA, Minamitsuru-gun (JP)

(21) Appl. No.: 14/620,264

(22) Filed: Feb. 12, 2015

(30) Foreign Application Priority Data
Feb. 17, 2014 (JP) 2014-027337

(51) Int. Cl. G05B 19/4065

(52) U.S. Cl. CPC G05B 19/4065; G05B 2219/37209

(57) ABSTRACT

Provided is a numerical controller for a machine tool having an efficient regular inspection function for components adjusted to the environment and condition of use of the machine tool. A state quantity for estimating the life of a component is measured and accumulated for each component, and a notification prompting inspection of the component is issued when a resultant cumulative value reaches a reference value. An inspection reference state quantity for determining timing for performing next inspection is renewed based on a result of inspection inputted by an inputting unit for inputting the result of inspection of the component.

### BACKGROUND OF THE INVENTION

1. Field of the Invention

The present invention relates to a numerical controller for a machine tool having a function of regularly inspecting components.

2. Description of the Related Art

A number of components are used in machine tools, which components are desirably inspected regularly and are replaced immediately when decided to have reached the end of life. It is however not always simple to manage the timing for inspection with respect to every component. Thus, as described in Japanese Patent Applications Laid-Open No. 02-173803, 10-320031, 2004-334507, and 07-225777, a technology is used by which an operation time of a machine or the number of use of components is accumulated so as to issue a notification to prompt an operator to inspect the components when the cumulative value exceeds a reference value for performing an inspection.

When a notification prompting inspection of a component is received from a controller of the machine tool, the operator inspects the component. In case where the operator decides that the life has come to an end as a result of the inspection, he/she replaces the component and resets the numerical value that has been accumulated up to that point in time. Some components involving regular inspection and replacement have the span of life that is prone to significant change depending on the environment and condition of use of the machine tool.

Thus, according to the aforementioned method described in Japanese Patent Applications Laid-Open No. 02-173803, 10-320031, and 2004-334507, the inspection cycle Is fixed regardless of the environment of use, which increases wasteful operations in the environment of use where the life of the component is extendable by setting a smaller reference value. Contrarily, in the environment of use where the life could be shortened by setting a larger reference value for the inspection cycle, the life of the component may reach an end before inspection is performed.

According to the aforementioned technology described in Japanese Patent Applications Laid-Open No. 07-225777, a reference value for performing inspection is changed on the basis of data on the environment of use; however, this involves preliminary setting of a plurality of reference values adjusted to difference in environment of use. In addition, in case where an element for which data is hard to obtain, such as the influence of coolant, factors into the length of life, it becomes more complicated to cope with the situation.

### SUMMARY OF THE INVENTION

Thus, view of the foregoing circumstances, an object of the present invention is to provide a numerical controller for a machine tool with a function of efficiently performing regular inspection of components adjusted to the environment and condition of use of the machine tool.

A numerical controller for a machine tool according to the present invention has a function of notifying timing for performing inspection of constituent components of a machine and include: a first recording unit configured to set and retain, for each of the components, an inspection reference state quantity which serves as a criterion for determining whether or riot the timing for performing inspection of the component has come; a cumulative value counter configured to measure and accumulate, for each of the components, a state quantity for estimating a life of the component and retain a resultant cumulative value; a notifying unit configured to issue a notification reminding of inspection timing of the component when the state quantity accumulated at the cumulative value counter reaches the inspection reference state quantity; an input unit configured to input a result of inspection of the component following the issuance of the notification reminding of the inspection timing of the component from the notifying unit; and a changing unit configured to change the inspection reference state quantity for determining timing for performing next inspection based on the result of inspection inputted by the input unit.

The numerical controller may further include a second recording unit configured to set. and record by component at least one extension state quantity for extending the inspection. reference state quantity retained at the recording unit when a decision is made that the component is continuously usable as a result of inspection of the component. The input unit may include: a first operation unit configured to be operated when an operator decides that the component is continuously usable; and a second operation unit configured to be operated when the operator decides that the life of the component has reached an end and replaces the component. And the changing unit may include: a first calculation unit configured to add, when the first operation unit is operated, the extension state quantity recorded at the second recording unit to the inspection reference state quantity recorded at the first recording unit to find an inspection reference state quantity for next inspection; and a second calculation unit configured to clear, when the second operation unit is operated, the state quantity accumulated by the cumulative value counter to find an inspection reference state quantity for next inspection.

The second recording unit may be configured to record the inspection reference state quantity to be extended in such a manner as to decrease in accordance with increase in number of operation of the first operation unit.

The second calculation unit may be configured to set a value obtained by multiplying the inspection reference state quantity found by the first calculation unit by a coefficient not larger than 1, as the inspection reference state quantity for the next inspection.

The first operation unit may be configured such that operation thereof is forbidden in case where the extension state quantity used for the extension. by the first calculation unit takes a minimum value among the extension state quantities recorded at the second recording unit.

The numerical controller may further include an environment information obtaining unit configured to obtain information on an environment having the machine or the component placed therein. The cumulative value counter may be configured to multiply the state quantity to be accumulated by a coefficient to find the cumulative value in case where a decision is made that the information obtained by the environment information obtaining unit is influential on the life of the component.

Embodiments of the present invention provide a numerical controller for a machine tool having an efficient regular inspection function for components adjusted to the environment and condition of use of the machine tool.

### BRIEF DESCRIPTION OF THE DRAWINGS

The above and other features of the present invention will become apparent from the following description of embodiments with reference to the accompanying drawings, in which:

FIG. 1 shows a process for notifying timing for inspection of a component to be performed by a numerical controller according to the present invention;

FIG. 2 is an explanatory diagram of a function provided to a numerical controller according to the present invention;

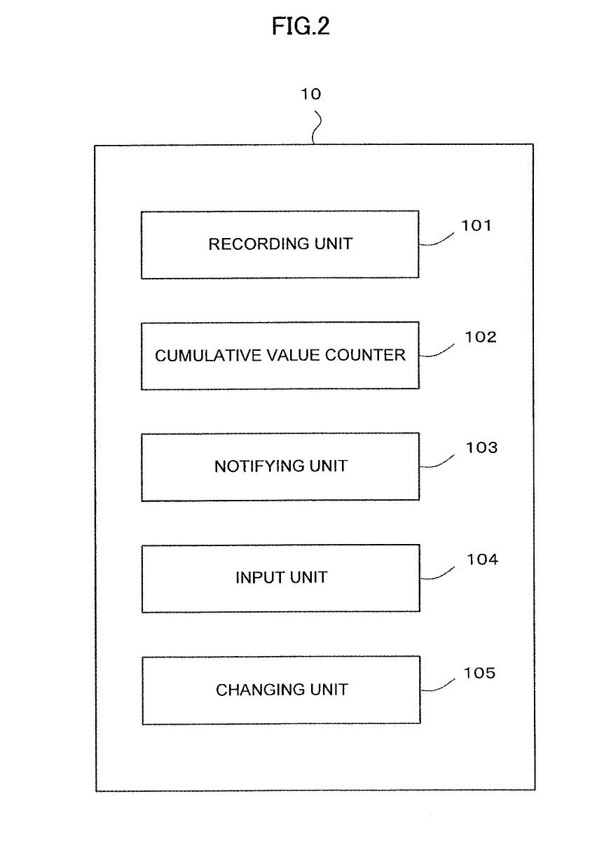

FIG. 3 is a block diagram of essential portions of a numerical controller according to one embodiment of the present invention; and

FIG. 4 is a flowchart showing a process for notifying timing for inspection of a component to be executed by a numerical controller according to the present invention.

### DETAILED DESCRIPTION OF THE PREFERRED EMBODIMENTS

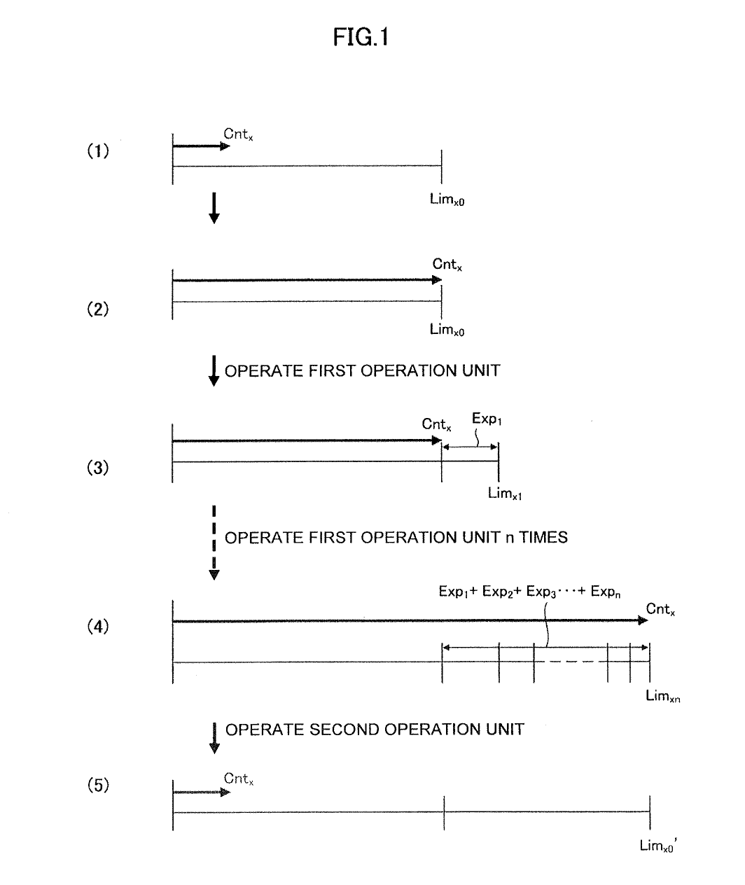

FIG. 1 shows a process for notifying timing for inspection of a component to be performed by a numerical controller according to the present invention.

In FIG. 1, (1) shows a state right after starting a regular inspection, (2) shows a state in which cumulative value Cntₓ of inspection state quantities including operation time and the number of use reaches initial value Limₓ₀ of an inspection reference state quantity, (3) shows a state in which a first operation unit (which is operated when an operator decides that the component is continuously usable) is operated for the first time, where an inspection reference state quantity is extended by Exp₁ to Limₓ₁, (4) shows a state in which the first operation unit is operated n times, where the inspection reference state quantity is extended by Expₙ to Limₓₙ, and (5) shows a state in which a second operation unit (which is operated when an operator decides that the life of the component has reached an end and replaces the component) is operated, where cumulative value Cntₓ is cleared and Limₓ₀′ is set for an inspection reference state quantity Limₓ₀ for the next inspection. The numerical controller defines, with respect to a component with component number x involving inspection and replacement, an inspection state quantity including operation time and the number of use for estimating the life of the component as cumulative value Cntₓ, and accumulates the value for record on a memory. Further, inspection reference state quantity Limₓ₀ serving as a criterion for performing inspection is set for each component and is recorded on the memory. Moreover, the numerical controller includes the aforementioned first and second operation units. The first operation unit is operated in case where the component is to be continuously used without replacement after inspection, whereas the second operation unit is operated in case where the component is replaced. The first operation unit and the second operation unit may be configured by, for example, a manual data input (MDI) 70 with a display of a numerical controller 10.

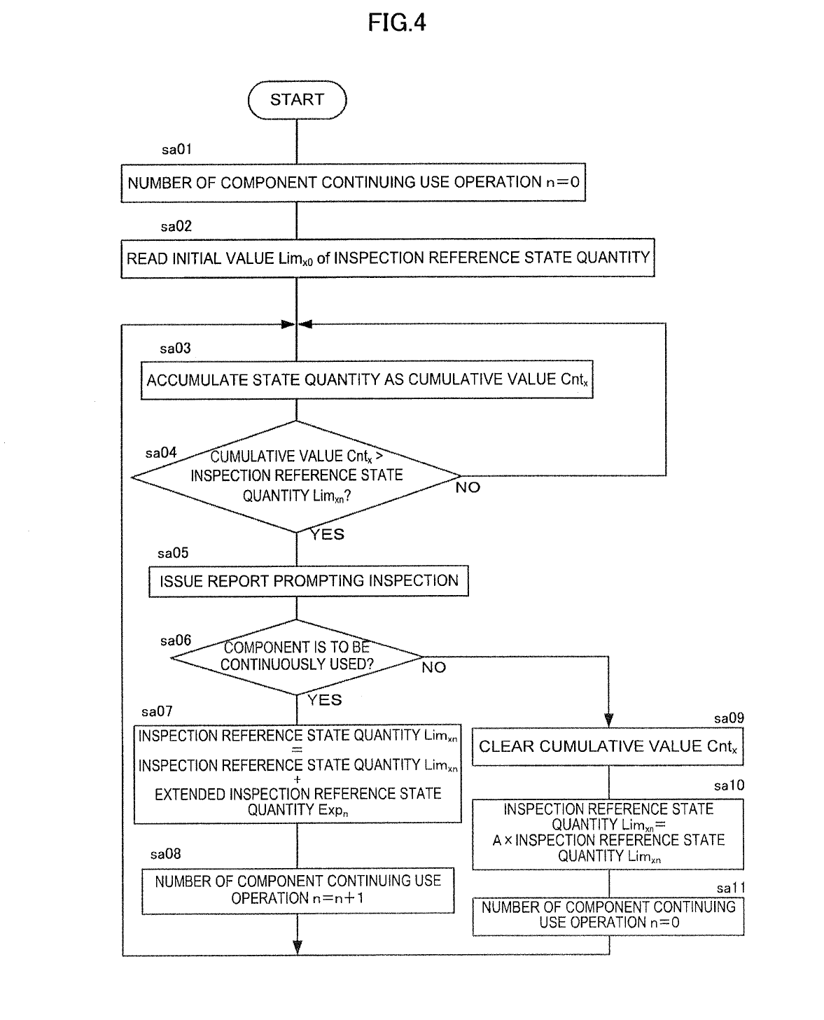

For each component involving inspection and replacement, cumulative value Cntₓ of inspection state quantities is updated by accumulation. It may be configured such that a state in which a machine or a component is placed is assessed from, for example, a control signal from the numerical controller, and that the cumulative value is multiplied by a coefficient in case where the assessed state is considered to be influential on the life of the component. For example, in case of a component whose life is likely to be affected dependent on whether coolant is used or not, reference is made of a code in a program for instructing discharge of coolant or a signal for controlling a coolant pump in the numerical controller, and in case where it is decided that coolant has been discharged, the cumulative value is multiplied by the coefficient, such that a value larger than that in the absence of coolant is to be accumulated. In a process shown in the flowchart of FIG. 4 (to be described later), cumulative value Cntₓ may be multiplied by the coefficient in Step sa03.

When cumulative value Cntₓ reaches inspection reference state quantity Limo, a notification is issued to the operator to the effect that the relevant component be inspected, by way of a method such as a message displayed on a screen (e.g., a display of the MDI unit 70 of the numerical controller 10). Upon receiving the notification, the operator conducts inspection of the relevant component, and in case where the component is not to be replaced and the use is continued as a result, the first operation unit is operated, whereas in case where the component is replaced as the life of the component has reached an end, the second operation unit is operated. This may be carried out by providing a “continue” button and a “replace” button on an operation board so as to be pressed at the time of inspection, or by displaying items such as “continue” and “replace” for selection on a screen of the numerical controller.

In case where the first operation unit is operated, cumulative value Cntₓ is not changed and the inspection reference state quantity is changed from Limₓ₀ to Limₓ₁, where

Limₓ₁=Limₓ₀+Exp₁.

Expₙ represents a quantity (a extension state quantity) by which the inspection reference state quantity is extended in case where the component is to be continuously used without replacement as a result of inspection, and a formula is recorded on the memory in advance, which formula is used for calculating the value based on a constant value or data obtained at the time of inspection.

Cumulative value Cntₓ is updated again by accumulation, and a notification is issued again when inspection reference state quantity Limₓ₁ is reached. The operator again conducts inspection of the relevant component in response to the notification, and the first operation unit is continued to be operated as long as the component is continuously used. Inspection reference state quantity Limₓₙ is represented by

Limₓₙ=Limₓ₀+Exp₁+Exp₂+ . . . +Expₙ

when the first operation unit is operated n times.

It is to be noted here that extension state quantity Ex becomes smaller as the number of operation of the first operation unit increases. More specifically,

Exp₁>Exp₂> . . . >Expₙ

is established. Fixed values satisfying the above equation may be used for Exp₁ to Expₙ. Alternatively, a formula may be prepared, and the extension state quantity may be decreased according to the formula.

Further, in case where extension state quantity Expₙ that is used for extension upon operation of the first operation unit takes a minimum value recorded on the memory, operation of the first operation unit is forbidden from then on.

In case where the life of the component reaches an end and the component is thus replaced as a result of inspection, the second operation unit is operated. When the second operation unit is operated, cumulative value Cntₓ is first cleared. At the same time, inspection reference state quantity Limₓ₀′ to serve as a criterion for performing next inspection is set. It is to be noted here that Limₓ₀′=A×Limₓₙ is established, where A is a coefficient in setting inspection reference state quantity Limₓ₀′ and A≦1.

By the above-described method, inspection reference state quantity Limₓ₀′ takes a value adjusted to a machine usage environment, and notifications thereafter are issued at appropriate intervals. Further, extension state quantity Expₙ is reduced as the number of operation of the first operation unit increases, such that a situation is avoided in which the component reaches the end of life before next inspection. In addition, the inspection reference value after the operation of the second operation unit is set to a more appropriate value. It is to be noted that identification of a minimum value among extension state quantities is facilitated by correlating each extension state quantity Expₙ with the number n of component continuing use operation in descending order.

The numerical controller 10 for a machine tool includes a recording unit 101, a cumulative value counter 102, a notifying unit 103, an input unit 104, and a changing unit 105. The recording unit 101 sets and retains, for each component, an inspection reference state quantity serving as a criterion for determining whether or not the timing for inspection of the component has come. The cumulative value counter 102 measures and accumulates a state quantity for estimating the life of each component, for each component, and stores the accumulated state quantities in a memory. The notifying unit 103 issues a notification prompting inspection of the component when the state quantity accumulated in the cumulative value counter 102 reaches the inspection reference state quantity. The input unit 104 inputs the result of inspection of the component. The changing unit 105 changes the inspection reference state quantity for determining the timing of next inspection based on the result of inspection inputted by the input unit 104.

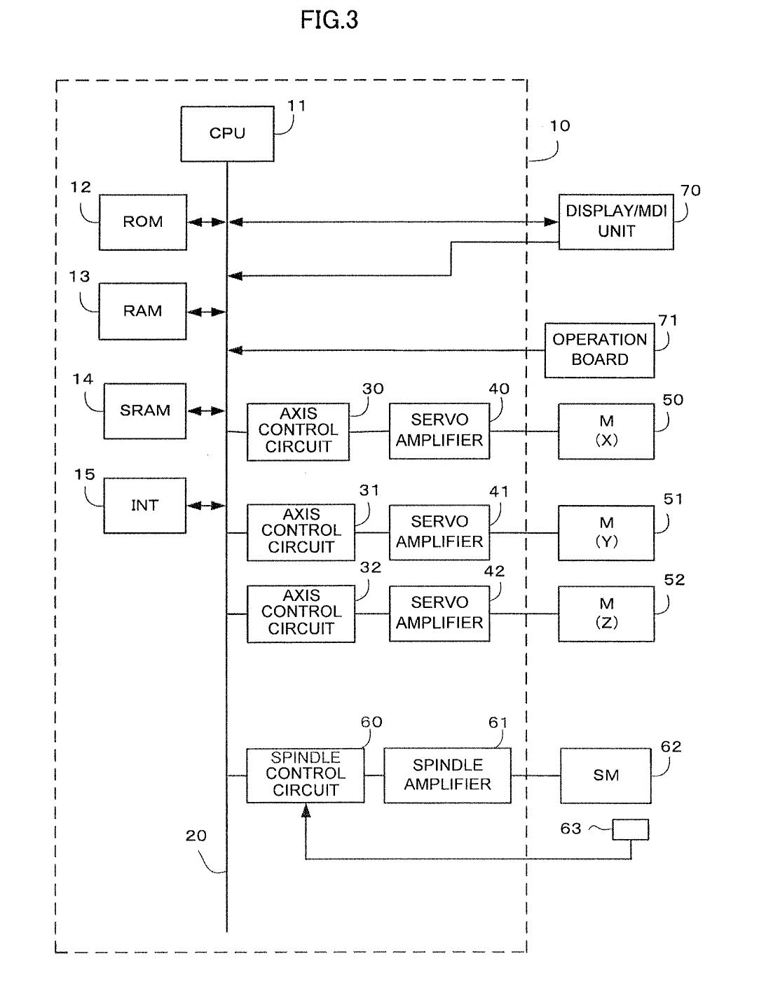

FIG. 3 is a block diagram of essential portions of the numerical controller according to one embodiment of the present invention.

A central processing unit (CPU) 11 reads out a system program stored on a read-only memory (ROM) 12 through a bus 20 and controls the entire numerical controller 10 according to the system program. A random access memory (RAM) 13 stores temporary calculation data and display data, as well as various data inputted by an operator by way of the display/MDI unit 70.

A static RAM (SRAM) 14 is configured as a non-volatile memory retaining the memory state even when the power of the numerical controller 10 is turned off. A machining program read through an interface 15 and a machining program inputted by way of the display/MDT unit 70 are retained on the SRAM 14.

Further, various system programs are written on the ROM 12 in advance so as to enable execution of processing in edit mode for creating and editing the machining programs or processing for automatic operation. Moreover, a program for performing efficient regular inspection of components according to the present invention is stored on the ROM 12.

Axis control circuits 30 to 32 for respective axes output instructions directed to each axis to servo amplifiers 40 to 42 in response to movement instructions for each axis from the CPU 11. In response to the instructions, the servo amplifiers 40 to 42 drive servo motors 50 to 52 each associated with the axes. The servo motors 50 to 52 each associated with the axes incorporate position/speed sensors. Position/speed feedback signals from the position/speed sensors are fed back to the axis control circuits 30 to 32, so as to perform feedback control with respect to the position and speed. It is to be noted that in FIG. 3, the feedback with respect to the position and speed is not illustrated.

The servomotors 50 to 52 give a drive to X, Y, and Z axes of the machine tool. A spindle control circuit 60 outputs a spindle speed signal to a spindle amplifier 61 in response to an instruction to rotate the spindle. The spindle amplifier 61 drives a spindle motor (SM) 62 at the instructed rotational speed in response to the spindle speed signal. The spindle motor (SM) 62 incorporates a speed sensor 63 therein and is configured to detect the rotational speed of the spindle motor (SM) 62 for feedback to the spindle control circuit 60.

The configuration of the numerical controller 10 as described above is the same as configurations of existing numerical controllers, and three-axes machining machine is driven and controlled by the numerical controller 10. Then, the processor (CPU) 11 of the numerical controller 10 executes software containing algorithms for performing regular inspection of the components.

FIG. 4 is a flowchart showing a process for notifying inspection timing of a component to be executed by the numerical controller according to the present invention. Description is given below in line with the steps of the flowchart.

[Step sa01] The number n of component continuing use operation is initialized (n=0).
[Step sa02] Initial value Limxo of the inspection reference state quantity is read. Initial value Limₓ₀ of the inspection reference state quantity is retained on the memory of the numerical controller in advance.
[Step sa03] State quantities are accumulated as cumulative value Cntₓ.
[Step sa04] Decision is made as to whether or not cumulative value Cntₓ accumulated in Step sa03 is larger than inspection reference state quantity Limₓₙ. In case where cumulative value Cntₓ is larger (YES), the process proceeds to Step sa05, and in case where cumulative value Cntₓ is not larger (NO), the process returns to Step sa03. Since initially n=0, inspection reference state quantity Limₓₙ takes initial value Limₓ₀ of the inspection reference state quantity read in Step sa02.
[Step sa05] A signal prompting inspection is issued. To issue such a signal, for example, a buzzer, a red light, or a message on a screen prompting inspection is used.
[Step sa06] Decision is made as to whether the component is to be continuously used or not. In case where continuing use of the component is decided (YES), the process proceeds to Step sa07, and in case where the continuing use of the component is not decided, i.e., replacement of the component is decided (NO), the process proceeds to Step sa09. Specifically, an operator presses a “continue” button or a “replace” button provided on the numerical controller 10 at the time of inspection of the component, such that information as to whether the component is to be continuously used or to be replaced is given the numerical controller 10.
[Step sa07] By adding inspection. reference state quantity for extension Expₙ to the inspection reference state quantity Limxn, the inspection reference state quantity Limₓₙ is renewed.
[Step sa08] By adding 1 to the number n of component continuing use operation, the number n of component continuing use operation is renewed, and the process returns to Step sa03.
[Step sa09] Cumulative value Cntₓ is cleared.
[Step sa10] A value obtained by multiplying inspection reference state quantity Limₓₙ by coefficient A is freshly set as inspection reference state quantity Limₓ₀. This process allows decision as to whether the life of the replaced component has reached an end to be made based on inspection reference state quantity Limₓₙ. In other words, inspection correlating to the usage environment of a machine (component) is carried out.
[Step sa11] The number n of component continuing use operation is initialized (n=0), and the process returns to Step sa03.

As has been described above, embodiments of the present invention provide a numerical controller for controlling a machine tool that has a regular inspection function by which preliminary preparation is eliminated and a reference value is settable so as to be adjusted to the machine usage environment. Further, embodiments of the present invention provide a numerical controller that has a function of notifying an operator of timing for inspecting a component, thereby enabling regular inspection of the component.

1. A numerical controller for a machine tool, the numerical controller having a function of notifying timing for performing inspection of constituent components of a machine, comprising:
a first recording unit configured to set and retain, for each of the components, an inspection reference state quantity which serves as a criterion for determining whether or not the timing for performing inspection of the component has come;
a cumulative value counter configured to measure and accumulate, for each of the components, a state quantity for estimating a life of the component and retain a resultant cumulative value;
a notifying unit configured to issue a notification reminding of inspection timing of the component when the state quantity accumulated at the cumulative value counter reaches the inspection reference state quantity;
an input unit configured to input a result of inspection of the component following the issuance of the notification reminding of the inspection timing of the component from the notifying unit; and
a changing unit configured to change the inspection reference state quantity for determining timing for performing next inspection based on the result of inspection inputted by the input unit.

2. The numerical controller for a machine tool according to claim 1, further comprising:
a second recording unit configured to set and record by component at least one extension state quantity for extending the inspection reference state quantity retained at the recording unit when a decision is made that the component is continuously usable as a result of inspection of the component, wherein
the input unit includes:
a first operation unit configured to be operated when an operator decides that the component is continuously usable; and
a second operation unit configured to be operated when the operator decides that the life of the component has reached an end and replaces the component, and
the changing unit includes:
a first calculation unit configured to add, when the first operation unit is operated, the extension state quantity recorded at the second recording unit to the inspection reference state quantity recorded at the first recording unit to find an inspection reference state quantity for next inspection; and
a second calculation unit configured to clear, when the second operation unit is operated, the state quantity accumulated by the cumulative value counter to find an inspection reference state quantity for next inspection.

3. The numerical controller for a machine tool according to claim 2, wherein the second recording unit is configured to record the inspection reference state quantity to be extended in such a manner as to decrease in accordance with increase in number of operation of the first operation unit.

4. The numerical controller for a machine tool according to claim 2, wherein the second calculation unit is configured to set a value obtained by multiplying the inspection reference state quantity found by the first calculation unit by a coefficient not larger than 1, as the inspection reference state quantity for the next inspection.

5. The numerical controller for a machine tool according to claim 4, wherein the first operation unit is configured such that operation thereof is forbidden in case where the extension. state quantity used for the extension by the first calculation unit takes a minimum value among the extension state quantities recorded at the second recording unit.

6. The numerical controller for a machine tool according to claim 1, further comprising an environment information obtaining unit configured to obtain information on an environment having the machine or the component placed therein, wherein
the cumulative value counter is configured to multiply the state quantity to be accumulated by a coefficient to find the cumulative value in case where a decision is made that the information obtained by the environment information obtaining unit is influential on the life of the component.
